(19) United States
(12) Patent Application Publication
(10) Pub. No.: US 2024/0051327 A1
(43) Pub. Date: Feb. 15, 2024

(54) OPTICAL SECURITY FEATURE SUITABLE FOR TRACK-AND-TRACE AND/OR SERIALIZATION SYSTEMS

(71) Applicant: Fraunhofer-Gesellschaft zur Förderung der angewandten Forschung e. V, München (DE)

(72) Inventors: Tobias Jochum, Hamburg (DE); Armin Wedel, Potsdam (DE); Jan Niehaus, Hamburg (DE); Bert Fischer, Potsdam (DE)

(21) Appl. No.: 17/766,333

(22) PCT Filed: Sep. 24, 2020
(86) PCT No.: PCT/EP2020/076720

§ 371 Date: Apr. 4, 2022

(30) Foreign Application Priority Data
Oct. 17, 2019 (DE) 10 2019 216 003.4

(51) Int. Cl. B42D 25/382

(52) U.S. Cl. CPC B42D 25/382

(57) ABSTRACT

The present invention relates to a method for identifying products with the aid of an ink formulation which contains semiconductive inorganic nanocrystals which emit radiation in the range of 750-1800 nm when excited by photons, in serialisation and/or track-and-trace systems.

The present invention is based on a method for identifying products with the aid of an ink formulation containing semiconducting inorganic nanocrystals which, when subjected to photon excitation, emit radiation in the range of 750-1800 nm, in serialization and/or track-and-trace systems.

### TECHNICAL BACKGROUND

Product counterfeiting causes global economic damage amounting to hundreds of billions of US dollars. In Europe alone product counterfeiting gives rise to economic damage amounting to more than 80 billion euros. The range of counterfeit products is immense. Cosmetics, watches, tobacco and medical products are increasingly being counterfeited. In 2019 the pharmaceutical and tobacco industries—as necessitated by EU Directives (2011/62/EU and 2014/40 EU)—introduced a serialization system for monitoring their products. In this case, every product packaging is equipped with a specific, unique code and the latter is stored in a central database. Several problematic scenarios arise here:
hacking of the database. In this respect, it must be taken into consideration that no IT system can be fully comprehensively safeguarded against hacker attacks by third parties. The hackers may either store/add their own codes in the central database or wait for the unique codes of the other companies. It is thus no longer possible to verify which product is a counterfeit and which product is the original.
passing on the codes to third parties. The unique codes may be passed on to third parties by personnel. The third parties can then print the codes onto the counterfeit products, with the result that these should be regarded as “genuine” according to the database.
the transfer of the codes to a different packaging. As soon as the code is transferred from the original packaging to the packaging of the duplicate and the original packaging is disposed of, counterfeit preparations can be sold as original products. This deception is difficult to track since the database system confirms that the present product is not a counterfeit. This risk scenario would be conceivable e.g. in the case of repackaging of stolen products/medicaments and in the case of illegal trade with products on the internet or with smuggled goods.

On account of these three critical points it is very important to establish a (physical) additional security feature in the unique code. The present invention tackles exactly this subject. This invention thus constitutes a combination of track-and-trace technology and optical security features. In this regard, the trace process and the authentication process of products are combined with one another.

With regard to security of products against counterfeiting, mainly two competing solutions have been elaborated in recent years, namely track and trace and authentication solutions, especially on an optical basis.

Track-and-trace programs (U.S. Pat. Nos. 9,027,147; 8,898,007; US 2009/0096871; U.S. Pat. No. 8,700,501) are used to ensure the unambiguous track and trace of all process steps in the production and supply chain. They additionally enable comprehensive monitoring possibilities for the manufacturer and transparency for the consumer, since locations and routes of products can be documented without gaps.

For authentication solutions, the interplay of security against counterfeiting and design is of elementary importance. In part highly decorative and innovative authentication solutions are used to protect the consumer against manipulation. They include authentication solutions which are visible to the human eye and also those which are invisible to the human eye.

One authentication solution which is invisible to the human eye uses organic dyes from the near infrared (NIR) range (EP 0 933 407; U.S. Pat. Nos. 5,282,894; 5,665,151; WO 1998/018871; WO 2003/038003; U.S. Pat. Nos. 10,119,071; 5,542,971). However, these organic NIR dyes have some disadvantages, such as a low quantum efficiency of less than 20%, a low thermal stability and also a high susceptibility to external influences such as e.g. oxidation or photobleaching, as a result of which even with little irradiation exposure these dyes often lose more than 50% of the original fluorescence intensity (quantum efficiency).

For authentication solutions, novel materials such as quantum dots and/or perovskites which likewise are fluorescent in the NIR range are additionally being researched (U.S. Pat. Nos. 9,382,432; 6,383,618; WO 2007/131043; Adv. Mater. (2005), 17, 5, 515; J. Am. Chem. Soc. (2008), 130, 9240; Analyst (2010), 135, 1867; Adv. Mater. (2019), 31, e1806105).

The present invention is based on the concept that the optical security feature is invisible to the human eye and can be detected only with the aid of optical detection systems (e.g. spectrometers or NIR camera systems) and optionally mobile terminals (e.g. smartphone, tablet etc.) or other corresponding readout devices. In this case, NIR beams are emitted by inorganic materials. This optical security feature is not discernible to the product counterfeiter via the human eye. It is only after excitation with higher energy than the emission signal (for example blue and/or white light) generated for example by terminals such as smartphone flash or tablet flash or correspondingly equipped readout devices, but also higher energetic NIR radiation, that the optical security feature emits NIR radiation. The latter is detected by the readout device.

The inorganic materials used are distinguished by a high stability vis-à-vis environmental influences and also a specific excitation and emission pattern, allowing the optical excitation and also the detection with the aid of commercially available terminals, such as smartphones or tablets. In addition, these materials have a high quantum efficiency of more than 20%, which is necessary for detection by means of such devices.

The products thus labelled are more secure against counterfeiting since the counterfeiters would have to synthesize the respective inorganic materials, disperse them in the respective ink formulations and print the respective coats. Furthermore, the inorganic material used can be identified directly with the aid of software (e.g. spectrometer for smartphone).

### Subject Matter of the Invention

The present invention relates to a method for identifying products, which method contains the following steps:
providing an ink formulation containing semiconducting inorganic nanocrystals which, when subjected to photon excitation, emit radiation in the range of 750-1800 nm;
generating a unique code for identifying a product;
printing the ink formulation onto at least one area of the surface of the product in the form of said unique code;
irradiating the product printed with the ink formulation with photons;
detecting the radiation emitted by the irradiated product in the range of 750-1800 nm.

The invention likewise relates to an optical security feature on at least one area of the surface of a product in the form of a unique code, which optical security feature contains semiconducting inorganic nanocrystals which, when subjected to photon excitation, emit radiation in the range of 750-1800 nm.

The invention furthermore relates to an optical security feature on at least one area of the surface of a product, which optical security feature contains semiconducting inorganic nanocrystals which, when subjected to photon excitation, emit radiation in the range of 750-1800 nm.

Furthermore, the invention relates to a serialization and/or track-and-trace system which contains an optical security feature including a unique code that has been printed onto the product as described herein.

In addition, the invention relates to the use of a unique code that has been printed onto a product as described herein as an optical security feature in a serialization and/or track-and-trace system.

The designation “products” within the meaning of the present invention encompasses the products themselves, in so far as capable of identification, their packagings, product tags, barcode cards and barcode labels, and all other possibilities by which a product would usually be identified during the production process and/or transport including documentation.

The designation “ink formulation” within the meaning of the present invention encompasses any arbitrary solvent and combinations of same and typical additives which are suitable for producing a printable liquid.

The designation “printing” within the meaning of the present invention encompasses the deposition of pigments onto or into a solid substrate. Typical examples are, but not exclusively, digital printing, inkjet printing, screen printing, transfer printing, stamp printing, roll to roll, printing without contact, laser printing and further methods.

### FIGURES

FIG. 1 shows an overview of one possible embodiment of the method according to the invention for identifying products.

FIGS. 2 a-d show examples of the method according to the invention for identifying products on the basis of a one-dimensional code. FIGS. 2 a-c show printed one-dimensional codes with ink formulations according to the invention with different print resolutions on white cardboard (FIG. 2 a: 350 dpi, FIG. 2 b: 400 dpi, FIG. 2 c: 450 dpi). FIG. 2 d shows the emission pattern of the one-dimensional code from FIG. 2 c

FIGS. 3 a-c show examples of the method according to the invention for identifying products on the basis of a two-dimensional code. FIGS. 3 a-c show printed two-dimensional codes with ink formulations according to the invention with different print resolutions on white cardboard (FIG. 3 a: 400 dpi, FIG. 3 b: 450 dpi, FIG. 3 c: 500 dpi).

FIGS. 4 a-b show examples of individual printing inaccuracies and printing defects of a single printer which are able to be used as an individual and unique pattern for generating a unique code.

### DETAILED DESCRIPTION OF THE INVENTION

The present invention relates to a method for identifying products, which method contains the following steps:
providing an ink formulation containing semiconducting inorganic nanocrystals which, when subjected to photon excitation, emit radiation in the range of 750-1800 nm;
generating a unique code for identifying a product;
printing the ink formulation onto at least one area of the surface of the product in the form of said unique code;
irradiating the product printed with the ink formulation with photons;
detecting the radiation emitted by the irradiated product in the range of 750-1800 nm.

Firstly, provision is made of an ink formulation containing semiconducting inorganic nanocrystals which, when subjected to photon excitation, emit radiation in the range of 750-1800 nm.

The ink formulation is preferably a commercially available ink formulation suitable for the deposition of pigments onto or into a solid substrate. Typical examples are, but not exclusively, digital printing, inkjet printing, screen printing, transfer printing, stamp printing, roll to roll, printing without contact, laser printing and further methods.

Said ink formulation can already contain color pigments. This has the effect that the unique code printed using the ink formulation is visible to the human eye. The detection of the radiation emitted by the irradiated product in the range of 750-1800 nm is thus a further optical security feature besides the visible unique code.

In another embodiment, the ink formulation contains no further color pigments in addition to the semiconducting inorganic nanocrystals. In this embodiment, the unique code printed using the ink formulation is not visible to the human eye owing to the concentration of the ink formulation. Consequently, the unique code is not immediately evident but rather can be discovered and read out only after the product that has been printed with the ink formulation has been irradiated with photons, by way of the detection of the radiation emitted by the irradiated product in the range of 750-1800 nm.

In a third embodiment, firstly a unique code is printed onto at least one surface of the product using a commercially available ink formulation. In a second step, the ink formulation containing the semiconducting inorganic nanocrystals is then printed onto the existing unique code at points in the form of drops and/or in the form of a further unique code. In this embodiment, the ink formulation according to the invention preferably contains no pigments, with the result that the drops and/or the further unique code are/is not visible to the human eye.

In a fourth embodiment, the unique code according to any of the preceding embodiments is printed onto at least one label, which is subsequently adhesively bonded onto at least one surface of the product.

In a fifth embodiment, the unique code according to any of the first three embodiments is printed onto product tags, barcode cards and/or barcode labels.

In a fifth embodiment, the ink formulation contains two or a plurality of, for example 2, 3, 4, 5, 6 or 7, differentially emitting semiconducting inorganic nanocrystals and also further color pigments. In this embodiment, the unique code printed using the ink formulation is visible to the human eye. The detection of the radiation emitted by the irradiated product in the range of 750-1800 nm is thus a further optical security feature besides the visible unique code. Both the different emission maxima and the respective (intensity) ratios can likewise be stored in at least one database.

In a sixth embodiment, the ink formulation contains two or a plurality of, for example 2, 3, 4, 5, 6 or 7, differentially emitting semiconducting inorganic nanocrystals without further color pigments. In this embodiment, the unique code printed using the ink formulation is not visible to the human eye owing to the concentration. The detection of the radiation emitted by the irradiated product in the range of 750-1800 nm is thus a further optical security feature besides the visible unique code. Both the different emission maxima and the respective (intensity) ratios can likewise be stored in at least one database.

The semiconducting inorganic nanocrystals are preferably selected from the group of perovskites, I-VI semiconductors, II-VI semiconductors, III-V semiconductors, IV-VI semiconductors, I-III-VI semiconductors, carbon dots and mixtures thereof.

Examples of suitable semiconducting inorganic nanocrystals are, inter alia, AgS, AgSe, AgTe, CdS, CdSe, CdTe, PbS, PbSe, PbTe, SnTe, ZnS, ZnSe, ZnTe, InP, InAs, Cu₂S, In₂S₃, InSb, GaP, GaAs, GaN, InN, InGaN, ZnSSe, ZnSeTe, ZnSTe, CdSSe, CdSeTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnHgSSe, ZnCdSeTe, ZnHgSeTe, CdHgSSe, CdHgSeTe, CuInS2, CuInSe₂, CuInGaSe₂, CuInZnS₂, CuZnSnSe₂, CuIn(S,Se)₂, CuInZn(S,Se)₂, AgIn(S,Se)₂.

Further suitable examples, but not exclusively, are perovskite materials having the general formula ABX₃ or A₄BX₆, wherein X can be selected from Cl, Br, I, O and/or mixtures thereof, where A can be selected from Cs, CH₃NH₃, CH(NH₂)₂, Ca, Sr, Bi, La, Ba, Mg and/or mixtures thereof, wherein B can be selected from Pb, Sn, Sr, Ge, Mg, Ca, Bi, Ti, Mn, Fe and/or mixtures thereof.

Furthermore, core/shell and/or core/multishells composed of semiconducting inorganic nanocrystal architectures composed of II-VI, III-V, IV-VI, I-VI, I-III-VI semiconductors or mixtures thereof, and also core/shell and/or core/multishells composed of perovskite materials, are further suitable examples.

The crystal lattice of the semiconducting inorganic nanocrystal can be doped additionally, but not exclusively, with one or more metal ions, such as, for example, Cu⁺, Mg²⁺, Co²⁺, Ni²⁺, Fe²⁺, Mn²⁺ and/or with one or more rare earth metals, such as, for example, ytterbium, praseodymium or neodymium.

The semiconducting inorganic nanocrystals preferably have an average particle size of 1 nm to 100 nm, more highly preferably of 2 nm to 50 nm, and most highly preferably of 3 nm to 15 nm, in at least one dimension, preferably in all dimensions. The average particle size can also be enlarged/modified by various methods. Typical examples are, but not exclusively, a silica shell, a titanium oxide shell, a halogen shell, and also further methods for increasing stability, masking, biocompatibility, water solubility and/or encapsulation.

The semiconducting inorganic nanocrystals are preferably photoluminescent substances which are brought to electronically excited energy states by absorption of light, and thereupon reach energetically lower energy states again with emission of light in the form of fluorescence.

The semiconducting inorganic nanocrystals are preferably excited (excitation) by visible light, such as blue or white light, and also higher energetic NIR radiation than the emission signal.

The semiconducting inorganic nanocrystals, when subjected to photon excitation, emit radiation having a wavelength in the range of 750 to 1800 nm, more highly preferably of 800 to 1400 nm, most highly preferably of 850 nm to 1100 nm. These wavelength ranges are in the non-visible near infrared range.

A property of the semiconducting inorganic nanocrystals that is of interest for the present invention is that their excitation and emission spectrum is dependent on their particle size, inter alia.

The proportion constituted by the semiconducting inorganic nanocrystals in the ink formulation is preferably 0.01 to 70.0% by weight, more highly preferably 0.05 to 40.0% by weight, most highly preferably 0.1 to 30.0% by weight, measured on the basis of the total weight of the ink formulation. A range of between 0.01-10.0% by weight is preferable for digital and inkjet printing.

The ink formulation can contain semiconducting inorganic nanocrystals which have at least one or all, preferably all, of the following properties in common: emission wavelength, emission distribution, emission maximum. In another embodiment, the ink formulation can contain mixtures of semiconducting inorganic nanocrystals which have different values for emission wavelength, emission distribution and emission maximum.

Furthermore, the ink formulation can contain the color pigments of the commercial inks. Commercial ink formulations can be used and they are admixed with the semiconducting inorganic nanocrystals.

The emitted radiation of the ink formulation can produce an individual fluorescence spectrum, which is dependent on the type, amount and particle size of the semiconducting inorganic nanocrystals.

In this case, the individual fluorescence spectrum can be detected by a spectrometer. The detected individual fluorescence spectrum can then be compared with a reference spectrum stored in a database.

In addition, said additional fluorescence spectrum can be used as a further security feature for an ink formulation individually mixed by the producer of the product.

The ink formulation for inkjet printing, for example, preferably has a reciprocal Ohnesorge number of less than 14, more highly preferably of 1 to 10, even more highly preferably of 1 to 8, and most highly preferably of 2 to 4.

In a further step, a unique code for identifying a product is generated.

For this purpose, with preference, firstly at least one reference variable, preferably a plurality of reference variables, of the product is encrypted with the aid of a unique key.

In this case, possible reference variables are for example reference variables concerning type and constitution of the product such as serial numbers, batch numbers, CAS number in the case of chemical products, concerning the production location, concerning the time of production, concerning the delivery location, concerning the producer, concerning the supplier, concerning the purchaser or the like.

The unique key can be an algorithm made available to the producer or created by the producer itself.

A code that is unique to the product, preferably to the individual packaging unit of the product, is generated by means of the encryption.

This unique code can be a one-dimensional code, such as a barcode, for example, a two-dimensional code, such as a QR code, for example, or a three-dimensional code, such as a colored barcode, for example. The unique code can also contain one or more patterns, such as, for example, areas, stripes, lines, geometric figures, such as circles, triangles, rectangles, polygons, etc., alphanumeric characters, images, or combinations thereof.

Furthermore, there is the possibility of extracting/deriving a unique code from random, arbitrary processes, such as, for example, from printing inaccuracies and printing defects during the method step according to the invention of printing the ink formulation onto at least one area of the surface of the product.

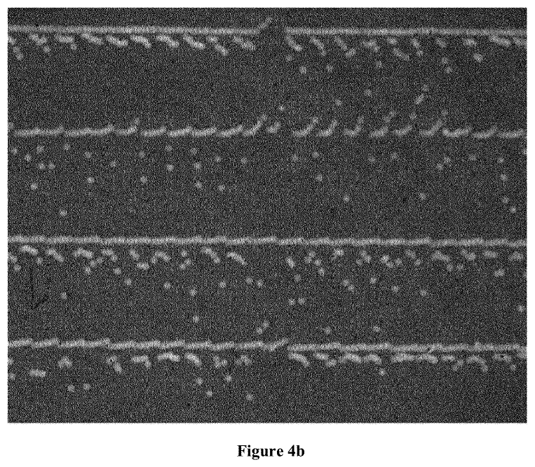

Viewed superficially, the print(out) usually shows no production inaccuracies at all. Viewed on the micrometer scale, however, an individual pattern is normally discernible. The latter may arise e.g. as a result of blockages of the printing nozzles, partial blockage of the printing nozzles, deflection of the ink drops or time-delayed placement of the ink drop from the printing nozzle. This gives rise to an arbitrary pattern at the micrometer level that is unique to each printing process (fingerprint). This pattern is visualized as an example in FIGS. 4 a and b. This unique pattern can be extracted by means of IT applications to form a unique code, which can be stored in the database in an encrypted manner as well. This form of the unique code makes it possible in a targeted manner to individualize individual objects, that is to say for example also individual species from a multi-part product series.

In one embodiment, with the aid of the ink according to the invention, a unique code that has already been established can be printed onto at least one surface of a product. The individual pattern obtained by way of printing inaccuracies and printing defects during this method step of printing the ink formulation onto at least one area of the surface of the product can then be used as an additional optical security feature and optionally be stored in a database. In this embodiment, the method step according to the invention of
generating a unique code for identifying a product;

is carried out before the method step of
printing the ink formulation onto at least one area of the surface of the product in the form of said unique code.

The method according to the invention in this embodiment is then after that by the method steps of
extracting an individual pattern caused by printing inaccuracies and printing defects during the printing of the unique code; and optionally
storing the individual pattern in at least one database.

In a further embodiment, the unique code can only be derived from the pattern printed using the ink formulation according to the invention. In this case, firstly a pattern as described herein is printed onto at least one surface of the product. This pattern is thereupon analyzed for printing inaccuracies and printing defects and an individual pattern is derived therefrom. This individual pattern can then be linked with the reference variables of the product as described herein and be utilized as a unique code and optionally be stored in a database.

In this embodiment, the method step according to the invention of
generating a unique code for identifying the product;

is carried out after the method step of
printing the ink formulation onto at least one area of the surface of the product in the form of said unique code.

The method according to the invention in this embodiment thus comprises the following method steps in the temporal order indicated:
printing the ink formulation onto at least one area of the surface of the product in the form of a unique code derived from an individual pattern caused by printing inaccuracies and printing defects during printing;
generating the unique code for identifying a product by encrypting at least one reference variable of the product with the aid of the individual pattern as a unique key.

This unique code composed of the individual pattern composed of printing inaccuracies and printing defects can also be encrypted, combined and/or encrypted and/or stored with another unique code, which was created by means of conventional methods and contains further reference variables of the product.

In this case, these two unique codes can be treated as individual unique codes, such that two unique codes are printed onto the product, which unique codes encrypt different reference variables of the product and are stored and detected as mutually independent individual codes. Both individual codes can be printed with the aid of the ink formulation according to the invention. However, the second unique code, which was created by means of conventional methods, can also be printed using a conventional ink formulation.

However, these two unique codes can also be combined to form a single unique code by a procedure in which, from the two individual unique codes, a combined unique code is generated as a one-dimensional code, two-dimensional code or three-dimensional code as described herein. This combined unique code can then subsequently in turn be printed onto the product with the aid of the ink formulation according to the invention. This embodiment thus comprises two temporally offset printing processes with the aid of the ink formulation according to the invention, in the following temporal order:
printing the ink formulation onto at least one area of the surface of the product in the form of a unique code consisting of an individual pattern caused by printing inaccuracies and printing defects during printing;
generating the unique code for identifying a product by encrypting at least one reference variable of the product with the aid of the individual pattern as a unique key;
combining the unique code with a further unique code to form a combined unique code;
printing the ink formulation onto at least one area of the surface of the product in the form of said combined unique code, and optionally
storing the combined unique code in at least one database.

The ink formulation is printed onto at least one area of the surface of the product in the form of said unique code. Preferably, each packaging unit of the product is printed with a dedicated unique code.

In this case, the step “printing the ink formulation onto at least one area of the surface of the product in the form of said unique code” comprises printing the ink formulation directly onto at least one area of the surface of the product, in so far as the physical nature of the product permits this, and also printing the ink formulation onto at least one label in the form of said unique code and labelling/tagging the surface of the product with at least one printed label.

If a direct identification is not permitted by the form and/or physical nature of the product, the step of “printing the ink formulation onto at least one area of the surface of the product in the form of said unique code” can also comprise printing the ink formulation directly onto at least one area of the surface of the packaging of the product or labelling/tagging the surface of the product with at least one printed label.

The customary printing methods are applicable for this purpose, depending on the type of ink formulation. The ink formulation is preferably printed onto at least one area of the surface of the product by means of digital printing, screen printing, transfer printing, roll-to-roll printing methods, “printing without contact” methods or laser printing.

Depending on the type of product, the unique code can be printed directly onto the surface of the product, onto the packaging of the product and onto labels, tags, barcode cards and/or barcode labels.

In addition to the unique code, the ink formulation can also be printed on at least one area of the surface of the product in other patterns, such as, for example, areas, stripes, lines, geometric figures, such as circles, triangles, rectangles, polygons, etc., alphanumeric characters, or combinations thereof. In this case, the printed pattern can serve as a pure authentication feature or contain information, such as safety and use advice or manufacturer information.

In a further step, the product printed with the ink formulation is irradiated with photons.

As a result of the photon irradiation, the semiconducting inorganic nanocrystals situated in the ink formulation are brought to excited energy states (excitation).

With preference, the product printed with the ink formulation is irradiated with visible light, preferably with blue or white light.

By way of example, a halogen lamp or an LED lamp, preferably a blue or white LED lamp, serves as light source. A suitable light source for the irradiation is moreover an LED flash, such as, for example, the LED flash of a terminal, such as e.g. a smartphone or tablet.

After irradiation, the irradiated product, preferably the semiconducting inorganic nanocrystals in the ink formulation, emits radiation in the range of 750 to 1800 nm, preferably of 800 to 1400 nm, most highly preferably of 850 nm to 1100 nm. This radiation is detected in a further step.

The emitted radiation can be detected by any detection device suitable for this.

Preferably, the emitted radiation is detected by a terminal, such as e.g. a smartphone or tablet. The camera systems of these terminals usually have a silicon-based image sensor that can detect incident photons up to a wavelength of approximately 1100 nm. Consequently, the radiation emitted by the semiconducting inorganic nanocrystals can be detected by means of these image sensors.

In order to be able to be excited and/or detected by a terminal, such as e.g. a smartphone or tablet, the photoluminescent substance, preferably the semiconducting inorganic nanocrystals in the ink formulation, must have a high quantum efficiency. The semiconducting inorganic nanocrystals in the ink formulation preferably have a quantum efficiency in the range of between 20-100%, more highly preferably in the range between 40-100%, most highly preferably 60-100%. In this case, the quantum efficiency or quantum yield indicates the ratio between the number of emitted and absorbed photons.

Depending on the respective embodiment of the printing process for the unique code, as described above, the unique code can also be read out with the aid of commercial barcode scanners if the unique code is visible to the human eye. In this embodiment, the detection of the emitted radiation of the semiconducting inorganic nanocrystals serves as a further security feature.

Consequently, the method according to the invention has the advantage of also being able to be employed by end consumers without additional financial expenditure. A simple and cost-effective method for verifying the authenticity of a product is thus available to trader and end consumer. The method according to the invention can thus be used as an authentication solution on an optical basis.

The method can furthermore also be used in serialization and/or track-and-trace systems.

In the case of serialization, structured data are mapped onto a sequential form of representation. Serialization is principally used for transmitting objects via the network in distributed software systems.

For use in serialization systems, the following further steps are preferred:
storing the unique code in at least one database;
retrieving the detected unique code from the at least one database in order to verify the product.

In more extensive serialization systems, one or more reference variables of a product can be acquired and/or encrypted with the aid of a unique key. A unique code is generated by means of a corresponding serialization and/or a track-and-trace computer program, and is printed onto the product. In addition, the code is stored in a database, preferably a central database. The code can then be scanned at any time and be read out from the database. The encrypted reference variables of the product can thus be read out by means of the serialization and/or track-and-trace computer program.

For use in track-and-trace systems, it is furthermore preferred for the ink formulation to be additionally printed onto at least one area of the surface of a packaging group containing the product, for example selected from bundles, external packaging, pallets, in the form of the unique code.

This enables the product to be tracked without gaps during the production and transport route of the individual product.

The present method thus constitutes a combination of track-and-trace technology and optical security features. In this regard, the trace process and the authentication process of products are combined with one another.

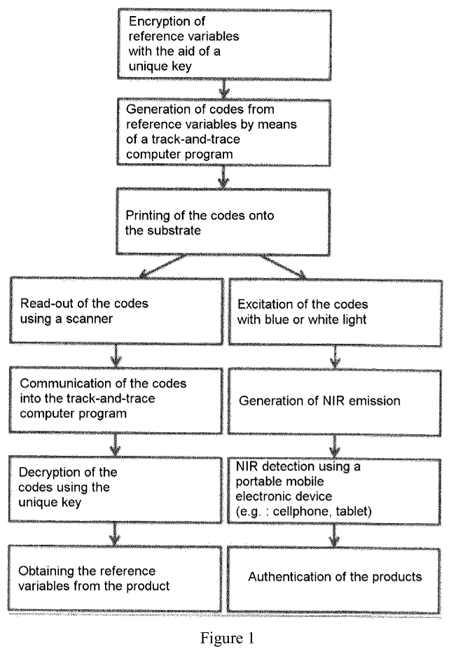

FIG. 1 shows an overview of one possible embodiment of the method according to the invention.

In this case, in a first step, reference variables of a product, such as, for example, production location and time period, constituents of the product, forms of administration, etc., are encrypted with the aid of a unique key.

Afterward, the generation of a code from these encrypted reference variables is carried out by means of a track-and-trace computer program. This code can be a one-dimensional code, two-dimensional code or three-dimensional code, e.g. a barcode, a QR code or a colored barcode.

This code is stored in a central database by means of the track-and-trace computer program.

In a next step, the code is printed onto the surface of the product with the aid of the ink formulation disclosed herein. Said ink formulation preferably contains further color pigments in addition to the semiconducting inorganic nanocrystals, such that the printed code is visible to the human eye. Depending on the product, the code can be printed directly onto the surface of the product or onto the packaging of the product.

The code printed with the aid of the ink formulation disclosed herein can then be used in two different ways, firstly as track-and-trace identification and secondly as optical authentication identification.

In a serialization or track-and-trace system, the code can be read out by a scanner. The code is communicated into the track-and-trace computer program. In this case, the code is read out from the database and decrypted. The reference variables of the identified product are thus obtained.

The code and all further possible identifications with the ink formulation disclosed herein can also be used as optical authentication identification.

For this purpose, the surface of the product is irradiated with light, preferably white or blue light, preferably white or blue LED light. The photoluminescent substance, preferably the semiconducting inorganic nanocrystals in the ink formulation, are excited here, as discussed above, and then emit fluorescence radiation in the range of 750-1800 nm (NIR radiation). This radiation cannot be perceived by the human eye. For the purpose of detection, an electronic device that can detect the NIR fluorescence radiation is necessary instead. What would be suitable would be for example spectrometers, NIR cameras, but also terminals, such as smartphones or tablets, which have in their camera systems a silicon-based image sensor that can detect incident photons up to a wavelength of approximately 1100 nm. These terminals can also be used for exciting the photoluminescent substance by means of the camera flash.

The control of the flash for excitation and the detection can be carried out via a corresponding app, such that after excitation and detection a corresponding photograph of the code appears on the screen of the terminal. This photograph thus serves as an optical authentication feature and allows the authentication of the product.

The method according to the invention thus extends a serialization or track-and-trace system by an optical security feature that is not visible to the human eye.

This optical security feature can be detected by simple means that are also available to the end consumer, such that a simple and cost-effective authentication is possible. The semiconducting inorganic nanocrystals used have a high quantum efficiency and are insensitive to temperature fluctuations, oxidation and photobleaching.

Security can be increased further by the use of a specific mixture of semiconducting inorganic nanocrystals having a specific particle size distribution and proportions in the ink formulation, which emits a specific fluorescence spectrum in the NIR range that can be detected with the aid of a spectrometer. This specific fluorescence spectrum can in turn be used as an additional authentication feature.

Compared with other authentication features such as RFID chips or holograms, the method according to the invention also has a clear cost advantage.

The present invention additionally also relates to an optical security feature on at least one area of the surface of a product in the form of a unique code, which optical security feature contains semiconducting inorganic nanocrystals which, when subjected to photon excitation, emit radiation in the range of 750-1800 nm.

Furthermore, the invention relates to an optical security feature on at least one area of the surface of a product, which optical security feature contains semiconducting inorganic nanocrystals which, when subjected to photon excitation, emit radiation in the range of 750-1800 nm.

In this case, the optical security feature is preferably printed on at least one area of the surface of the product by the method according to the invention.

The present invention furthermore relates to a serialization and/or track-and-trace system which contains an optical security feature including a unique code that has been printed onto a product as described herein.

In addition, the invention relates to the use of a unique code that has been printed onto a product as described herein as an optical security feature in a serialization and/or track-and-trace system.

In this case, the unique code is printed onto the product or the product packaging with the aid of the ink formulation described herein, which ink formulation contains semiconducting inorganic nanocrystals which, when subjected to photon excitation, emit radiation in the range of 750-1800 nm.

The features of the code, of the ink formulation and of the semiconducting inorganic nanocrystals as described herein are also applicable to the optical security feature according to the invention, the serialization and/or track-and-trace system according to the invention and also the use according to the invention.

The features of the serialization and/or track-and-trace system as described herein are likewise applicable.

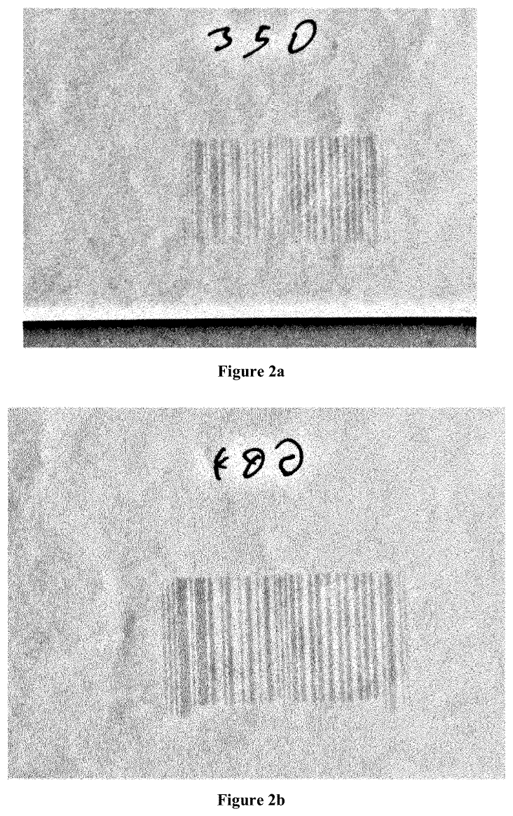

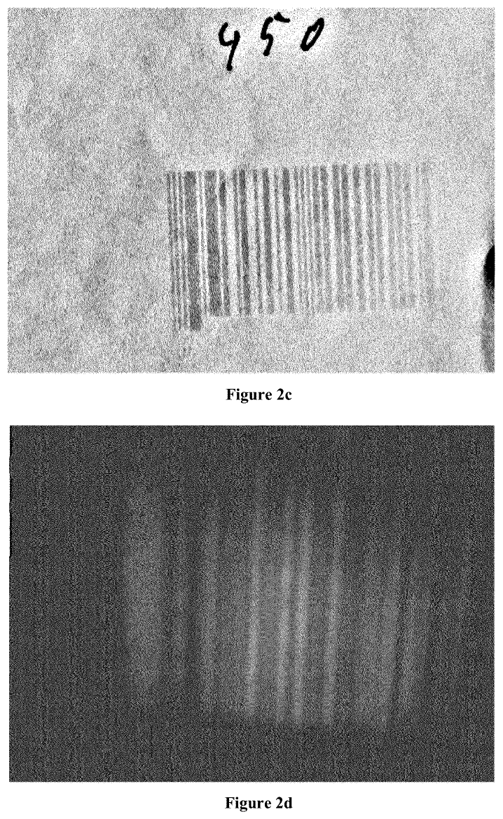

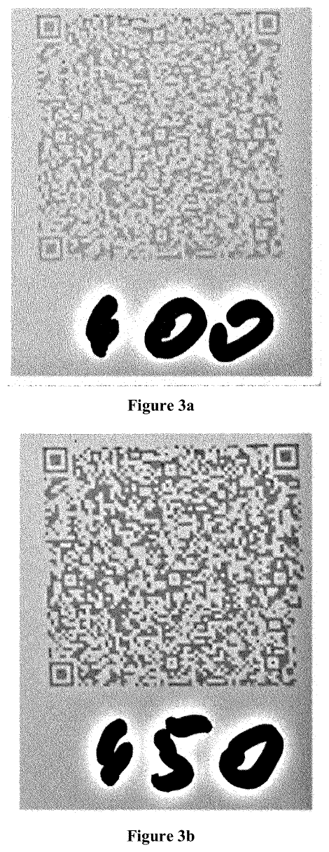

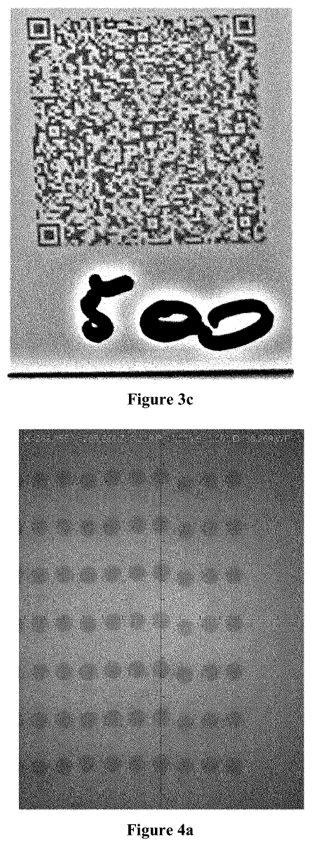

FIGS. 2 a-d show examples of a one-dimensional barcode printed on white cardboard. FIGS. 3 a-c show further examples of a two-dimensional QR code printed on white cardboard.

The ink formulation had the following constituents:
12 ml 1-decanol
8 ml 1-octanol
100 mg lead sulfide nanoparticles

The proportion constituted by the inorganic nanocrystals in the ink formulation is thus 0.6%. The viscosity of this ink formulation is 11 mPa*s.

Printability is crucial in the case of ink formulations. It is defined by way of the reciprocal Ohnesorge number. If this value is greater than 14, then the ink formulation is unsuitable for inkjet printing (digital printing). Values of the Ohnesorge number of between 1-10 are acceptable for inkjet technology. The values between 2-4 are the best, however.

Said Ohnesorge number is determined principally by the viscosity and the surface tension of the ink formulation.

In FIGS. 2 a-c, a barcode was printed with different resolutions of 350 dpi (FIG. 2 a), 400 dpi (FIG. 2 b) and 450 dpi (FIG. 2 c) by means of an inkjet printer. By virtue of the color pigments present in the ink formulation, the code is discernible to the human eye at any time.

The code in FIG. 2 c was additionally irradiated with white LED light and the emitted radiation in the NIR range was detected. FIG. 2 d shows a recording of the fluorescence radiation in the NIR range that was emitted by the ink formulation.

In FIGS. 3 a-c, a QR code was printed with different resolutions of 400 dpi (FIG. 3 a), 450 dpi (FIG. 3 b) and 500 dpi (FIG. 3 c) by means of an inkjet printer. By virtue of the color pigments present in the ink formulation, the code is discernible to the human eye at any time.

The higher the resolution, the better the discernibility of the code.

FIGS. 4 a and b show examples of individual printing inaccuracies and printing defects of a single printer, which are able to be used as an individual and unique pattern for generating a unique code.

The printed image in FIG. 4 a was produced using the printer LP50 from Süss MicroTec and the printhead from Spectra SE128 AA from Fujifilm. The ink formulation was the Spectra Testtinte Blue, likewise from Fujifilm. The photographs were taken using the Printview camera of the LP50. The graduation marks of the “crosshairs” have a scale of 100 μm. The substrate was photographic paper. Within a row of printed dots, an individual pattern of vertical displacements is evident. In particular, the third from last printed dot in a row has a significant difference in level with respect to its neighboring dots.

The printed image in FIG. 4 b was produced using the printer LP50 and the printhead from Spectra SE128 AA. The ink formulation was a mixture of SPR001 (commercial fluorescent polymer from Merck), chlorbenzene, mesitylene and tetralin. The photographs were taken using the camera acA 1300gc from Basler (lens focal length: 200 mm) at 2× magnification. Image detail 6×4 mm. The substrate was photographic paper. Within a row of printed dots, an individual pattern of vertical displacements, defects and omissions is evident at a smaller magnification than in FIG. 4 a.

1. A method for identifying products, the method comprising the following steps:
providing an ink formulation containing semiconducting inorganic nanocrystals which, when subjected to photon excitation, emit radiation in the range of 750-1800 nm, preferably of 800 to 1400 nm, most highly preferably of 850 nm to 1100 nm;
generating a unique code for identifying a product;
printing the ink formulation onto at least one area of the surface of the product in the form of said unique code;
irradiating the product printed with the ink formulation with photons;
detecting the radiation emitted by the irradiated product in the range of 750-1800 nm, preferably of 800 to 1400 nm, most highly preferably of 850 nm to 1100 nm.

2. The method according to claim 1, further comprising the following steps:
storing the unique code in at least one database;
retrieving the detected unique code from the at least one database in order to verify the product.

3. The method according to claim 1, wherein the ink formulation is additionally printed onto at least one area of the surface of a packaging group containing the product, for example selected from bundles, external packaging, pallets, and/or onto product tags, barcode cards and barcode labels in the form of the unique code.

4. (canceled)

5. The method according to claim 1, wherein for the purpose of generating the unique code, at least one reference variable of the product is encrypted with the aid of a unique key.

6. The method according to claim 1, wherein the unique code is a one-dimensional code, a two-dimensional code or a three-dimensional code.

7. The method according to claim 1, wherein the unique code contains one or more patterns, such as, for example, areas, stripes, lines, geometric figures, such as circles, triangles, rectangles, polygons, etc., alphanumeric characters, or combinations thereof.

8. The method according to claim 1, wherein the unique code is generated by printing inaccuracies and printing defects during the method step of printing the ink formulation onto at least one area of the surface of the product.

9. The method according to claim 1, wherein the ink formulation is printed onto at least one area of the surface of the product in other patterns, such as, for example, areas, stripes, lines, geometric figures, such as circles, triangles, rectangles, polygons, etc., alphanumeric characters, images or combinations thereof, in addition to the unique code and/or
wherein the ink formulation is printed onto at least one area of the surface of the product by means of digital printing.

10. (canceled)

11. The method according to claim 1, wherein the product printed with the ink formulation is irradiated with blue or white light for the purpose of excitation.

12. The method according to claim 1, wherein a terminal, such as e.g. a smartphone or tablet, is used for the purpose of irradiation and/or detection.

13. The method according to claim 1, wherein the semiconducting inorganic nanocrystals are selected from the group of perovskites, I-VI semiconductors, II-VI semiconductors, III-V semiconductors, IV-VI semiconductors, I-II-VI semiconductors, carbon dots and mixtures thereof and/or wherein the semiconducting inorganic nanocrystals are doped with one or more metal ions, preferably selected from the group of Cu⁺, Mg²⁺, Co²⁺, Ni²⁺, Fe²⁺, Mn²⁺, and/or with one or more rare earth metal ions, preferably selected from the group of ytterbium, praseodymium and neodymium.

14.-19. (canceled)

20. The method according to claim 1, wherein the semiconducting inorganic nanocrystals in the ink formulation have a quantum efficiency in the range of between 20-100%, more highly preferably in the range between 40-100%, most highly preferably in the range of between 60-100%.

21. The method according to claim 1, wherein the ink formulation contains semiconducting inorganic nanocrystals which have at least one or all of the following properties in common: emission wavelength, emission distribution, emission maximum, or mixtures of semiconducting inorganic nanocrystals which have different values for emission wavelength, emission distribution and emission maximum.

22. (canceled)

23. (canceled)

24. The method according to claim 1, wherein the emitted radiation produces an individual fluorescence spectrum, which is stored in at least one database.

25. The method as claimed in claim 24, wherein the individual fluorescence spectrum is detected by a spectrometer.

26. An optical security feature on at least one area of the surface of a product in the form of a unique code, comprising semiconducting inorganic nanocrystals which, when subjected to photon excitation, emit radiation in the range of 750-1800 nm.

27. An optical security feature on at least one area of the surface of a product, comprising semiconducting inorganic nanocrystals which, when subjected to photon excitation, emit radiation in the range of 750-1800 nm.

28. The optical security feature according to claim 26, wherein the unique code is generated by printing inaccuracies and printing defects during the printing of an ink formulation containing semiconducting inorganic nanocrystals which, when subjected to photon excitation, emit radiation in the range of 750-1800 nm, preferably of 800 to 1400 nm, most highly preferably of 850 nm to 1100 nm, onto at least one area of the surface of the product.

29. A serialization and/or track-and-trace system comprising an optical security feature which contains a unique code that has been printed onto a product according to claim 1.

30. (canceled)

31. The optical security feature as claimed in claim 27, wherein the unique code is generated by printing inaccuracies and printing defects during the printing of an ink formulation containing semiconducting inorganic nanocrystals which, when subjected to photon excitation, emit radiation in the range of 750-1800 nm, preferably of 800 to 1400 nm, most highly preferably of 850 nm to 1100 nm, onto at least one area of the surface of the product.
